(19) United States
(12) Patent Application Publication
(10) Pub. No.: US 2010/0268712 A1
(43) Pub. Date: Oct. 21, 2010

(54) SYSTEM AND METHOD FOR AUTOMATICALLY GROUPING KEYWORDS INTO AD GROUPS

(75) Inventor: Americ Banyiyezako Ngwije, Burbank, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/424,521

(22) Filed: Apr. 15, 2009

(51) Int. Cl. G06F 17/30

(52) U.S. Cl. 707/737; 707/E17.074

(57) ABSTRACT

A system and method for automatically grouping keywords into a plurality of ad groups. The method includes receiving a list of keywords and calculating a frequency of occurrence associated with each keyword in the list of keywords. The keywords in the list of keywords are automatically grouped into a plurality of ad groups based on at least the frequency of occurrence or a predetermined ad grouping list. The plurality of ad groups are subsequently saved in an uploadable format and exported to an external application.

### SUMMARY

The present application provides a system and method for automatically grouping keywords into a plurality of advertisement groups (“ad groups”). The system includes a keyword database configured to receive a list of keywords. A word frequency engine in communication with the keyword database is configured to calculate a frequency of occurrence associated with each keyword in the list of keywords. The frequency of occurrence is based on the frequency a given keyword occurs within the list of keywords stored in the keyword database.

The system further includes a categorization engine for categorizing the list of keywords according to the frequency of occurrence. A keyword allocation module in communication with the categorization engine is provided for allocating the list of keywords into a plurality of ad groups according to the frequency of occurrence. The plurality of ad groups are stored into an ad group database and may be subsequently exported to an external application.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for automatically grouping keywords into ad groups;

FIG. 2 is a graphical user interface for automatically grouping keywords into ad groups in accordance with the system of FIG. 1;

FIG. 3 is an enlarged view of the “Source Keywords” field depicted in FIG. 2;

FIG. 4 is an enlarged view of the “Create Ad Groups” field depicted in FIG. 2;

FIG. 5 is a flowchart illustrating a method for automatically grouping keywords into ad groups; and

FIG. 6 is a schematic view of a computer system for implementing the methods described.

### DETAILED DESCRIPTION

With the advent of the Internet, Internet-based advertising has become increasingly popular among advertisers for promoting products and services. Advertisements may comprise banner ads, links to web pages, images, video, text, etc. The various advertisements used to promote products on the Internet may be displayed according to a variety of formats, such as in conjunction with a ranked result set in response to a query, embedded in a web page, a pop-up, etc.

Client devices, communicatively coupled to a network such as the Internet, are capable of accessing various websites that may display advertisements. For example, a user of a client device may submit a search request comprising one or more terms to a search engine, which causes the search engine to retrieve a result set comprising links to content, as well as advertisements responsive to the search terms provided by a user. The search engine generates and displays a result set to a user who may then select or view items in the result set, including one or more advertisements. Revenue for the search engine provider is typically generated from the advertisements displayed to users in response to search requests.

More specifically, online advertisers generally purchase keywords related to advertisements sought to be displayed. In this regard, it is not uncommon for a company to purchase hundreds or even thousands of keywords from one or more search engine providers such as Yahoo! Inc. and Google Inc. Yet the management of such large numbers of keywords can be quite burdensome. For instance, the keywords may be inputted into documents or spreadsheets such as those provided by Microsoft Corporation (e.g., Word®, Excel®, etc.) and subsequently allocated into ad groups in accordance with a given company's ad campaign strategy. The foregoing process, however, is predominantly manual and generally involves a great deal of copying, pasting, and sorting. Upon completion, the spreadsheet is converted and uploaded to a search engine. Depending on the number of keywords, the foregoing process may take anywhere from one to ten hours or more to complete. Since the time required for completing the ad grouping process is a function of the amount of keywords required to be grouped, an automated technique for grouping keywords into ad groups would expedite and increase the overall efficiency of the ad grouping process.

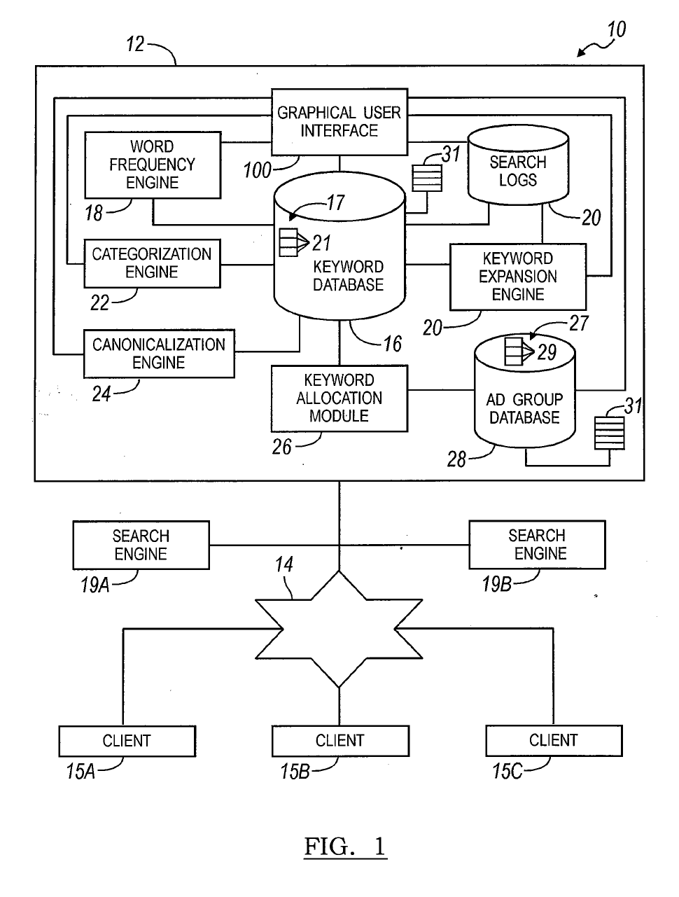

Referring now to FIG. 1, a system embodying the principles of the present application is illustrated therein and designated at 10. The system 10 comprises a server 12 capable of being in communication with a distributed network 14, which may include a connection to one or more local and/or wide area networks, such as the Internet. The server 12 may be a computing device, for example, operable to responsively execute requests from one or more users. While only one server 12 is depicted in the drawings, it should be understood to those of ordinary skill in the art that the system 10 may incorporate a plurality of servers.

The server 12 includes a storage unit, configured as a keyword database 16, which may be implemented as any type of data storage structure capable of providing for the retrieval and storage of a variety of data types. For instance, the storage unit may comprise one or more accessible memory structures such as a database, CD-ROM, tape, digital storage library, memory stick, etc. The keyword database 16 maintains one or more lists 17 of keywords 21. As used herein, it is to be understood that unless otherwise specified, the term “keyword” may refer to a single word (e.g., “boats”), or a string of words (e.g., “Chicago Bulls” or “The Phantom of the Opera”).

The keyword database 16 is communicatively linked to a word frequency engine 18. The word frequency engine 18 retrieves the list 17 of keywords 21 from the keyword database 16 and is operable to calculate a frequency of occurrence associated with each keyword in the keyword database 16. As will be explained in further detail below, the word frequency engine 18 determines how frequently a given keyword occurs in the list 17 of keywords 21 stored in the keyword database 16. As a result, keywords may be grouped into ad groups according to their corresponding frequency of occurrence. In addition, since keywords may include a single word or a string of words, the word frequency engine 18 is configured to calculate the frequency of occurrence according to a specific or defined number of words comprising each keyword.

For instance, if the keyword database 16 includes a list 17 of keywords 21 relating to an ad campaign for “Starbucks,” the word frequency engine 18 is operable to calculate the frequency of occurrence for each keyword according to any keyword size (i.e., the number of words making up the keyword). According to a “two word frequency,” for example, the word frequency engine 18 would determine how many times a keyword including two or more words such as “Starbucks Coffee,” “Starbucks Menu,” and “Starbucks Coffee Franchise,” occurs in the list 17. Assuming the foregoing three keywords comprised the entire list, the word frequency engine 18 would calculate that the keyword “Starbucks Coffee” has a frequency of occurrence equal to two, whereas the keyword “Starbucks Menu” has a frequency of occurrence equal to one. The frequency of occurrence associated with each keyword is stored in the keyword database 16 and displayed to a graphical user interface 100.

The server 12 is communicatively coupled to at least one search engine 19A, 19B for processing and receiving search requests comprising one or more keywords. In addition, the server 12 comprises a computer or controller such as a traffic monitor (not shown) for recording events associated with the keywords. Recorded events may include page hits, search requests, clicks, downloads, purchases, or any other recordable actions. According to a preferred embodiment, for example, one or more search logs 20 in communication with the search engine(s) 19A, 19B are provided to log or track the number of search requests conducted by users over the network 14. As illustrated in FIG. 1, the search logs 20 are communicatively linked to the keyword database 16 and are configured to retrieve the list 17 of keywords and calculate a historical search volume associated with each keyword 21 contained therein. More particularly, the search logs 20 are operable to indicate the total number of searches requests conducted by a user for each keyword stored within the keyword database 16 during a predetermined period of time. By way of example, the search logs 20 may be configured to track the total number of searches conducted for a given keyword (e.g., “Car Insurance”) on a particular website such as Yahoo! (www.Yahoo.com) during the past day, week, month, etc. The historical search volume associated with each keyword 21 is stored in the keyword database 16 and displayed to the graphical user interface 100.

Thus, the search logs 20 may be used to measure traffic at a given website, where the term “traffic” refers to a count, or approximate count, of the search requests (or any other recordable event) that occurred for a given subject. “Traffic” might be a raw count of the number of events, normalized or unnormalized, but traffic might also be measured not with one count per event, but one count per unique user (i.e., even if a particular user makes multiple requests, only one request is counted) or one count per unique user per time period might also be the measure of counting traffic. Traffic can be unnormalized, such as integer counts for the number of search requests, or can be normalized for a topic, term, or category. One purpose for normalization is to place the number in a suitable value range for presentation or other processing.

By linking the search logs 20 to the keyword database 16, keywords may be grouped into ad groups 27 according to a total volume of searches conducted by users via client devices 15A, 15B, and 15C communicatively linked to the network 14 during a specified time period. For instance, keywords having high volumes of search requests may be grouped together. Similarly, keywords having low volumes of search requests may be grouped together. Moreover, the system 10 may also be configured to automatically discard certain keywords from the keyword database 16 which have a corresponding volume of search requests falling below a predetermined threshold (e.g., less than 10 searches a month). Alternatively, such low volume keywords may simply be ignored (i.e., not grouped) during the ad grouping process. Furthermore, it should be understood that keywords may similarly be grouped according to any recordable event mentioned above (e.g., historical click-through rate, number of downloads, etc.).

The server 12 also includes a categorization engine 22 and a canonicalization engine 24 (or deduplication engine) communicatively linked to the keyword database 16. As will be discussed in greater detail below, the categorization engine 22 is configured to retrieve the list 17 of keywords 21 from the keyword database 16 and categorize the list 17 of keywords 21 according to a predetermined standard and/or user preferences. The categorization engine 22 subsequently displays the categorized list 17 of keywords 21 to the graphical user interface 100.

The canonicalization engine 24 is configured to retrieve the list 17 of keywords 21 from the keyword database 16 and reduce the list 17 of keywords 21 according to a universal, standard form. Pursuant to one embodiment, the canonicalization engine 24 is designed to reduce a set of similar keywords contained in the list 17 of keywords 21 according to a common denominator, or more specifically, according to an identical (or similar) keyword contained within the set of keywords. By way of example, if the list 17 of keywords 21 includes a set of similar keywords such as “car,” “cars,” “my car,” “my cars,” etc., the canonicalization engine 24 may be operable to reduce the foregoing set of keywords to “car.”

It should be understood to those of ordinary skill in the art that the aforementioned canonicalization example is merely intended for purposes of illustration, as other canonicalization techniques may be similarly implemented. For instance, canonicalization processes may include canonicalization ranging from less aggressive processes such as removing certain punctuation characters or so-called “stop words” such as “of” and “the,” to more aggressive processes such as adding, changing or deleting letters within words.

The server 12 further includes a keyword allocation module 26 communicatively linked to the keyword database 16. As will be discussed in greater detail below, the keyword allocation module 26 is configured to allocate the keywords stored in the keyword database 16 into a plurality of ad groups 27 based on a predetermined standard and/or user defined preferences, wherein each ad groups 27 includes a set of keywords 29 selected from the list 17 of keywords 21. The plurality of ad groups 27 are subsequently stored in an ad group database 28 and displayed to the graphical user interface 100.

Additionally, the plurality of ad groups 27 may be saved as an uploadable file format that may be automatically or selectively exported to an external application such as a spreadsheet commonly known as a “bulk sheet.” The ad group database 28 may be implemented as any type of data storage structure capable of providing for the retrieval and storage of a variety of data types. For instance, the ad group database 28 may comprise one or more accessible memory structures such as, but not limited to, a database, CD-ROMs, tapes, digital storage libraries, floppy disks, optical disks, magnetic-optical disks, erasable programmable read-only memories (EPROMs), random access memories (RAMs), magnetic or optical cards, etc.

According to one aspect of the present application, the system 10 includes a keyword expansion engine 30 communicatively linked to the server 12. The keyword expansion engine 30 is configured to receive one or more terms and responsively generate a plurality of related keywords. The plurality of related keywords may be generated according to various algorithms. For instance, the keyword expansion engine 30 may employ a keyword recommendation strategy such as the query expansion techniques utilized by Yahoo! Inc. and Google Inc. More particularly, the keyword expansion engine 30 may generate a plurality keywords based on usage patterns, user relevance feedback, user behavior, content, etc. In addition, the keyword expansion engine 30 may generate a plurality of keywords semantically related to the term(s) received by way of the system and method disclosed in U.S. Patent Publication No. 20090037399 to Bartz et al., which is commonly assigned to the assignee of the present application and is incorporated herein by reference in their entirety for all purposes.

The keyword expansion engine 30 may be linked to the search logs 20 and thereby operable to analyze terms logged therein with respect to the term(s) received. For instance, if the keyword expansion engine 30 receives the term “president,” the keyword expansion engine 30 may analyze the search logs 20 for all terms relating to “president” (e.g., “President Obama,” “President of the United States,” “U.S. Presidential Candidates,” etc.) that have been searched over a predetermined period of time. Accordingly, the keyword expansion engine 30 may generate a plurality of keywords comprising a predetermined number of related terms detected within the search logs 20. Moreover, a user may specify various metrics that the keyword expansion engine 30 must adhere to in generating the plurality of keywords. By way of example, a user may instruct the keyword expansion engine 30 to only generate keywords having a search volume (or click-through rate) exceeding a predetermined threshold. Similarly, the keyword expansion engine 30 may be configured to only retrieve keywords containing a specific term (e.g., each keyword in the list 17 of keywords 21 generated by the keyword expansion engine 30 must include the term “blue”).

The keyword expansion engine 30 is preferably incorporated within the server 12 and communicatively linked to the keyword database 16. However, it is to be understood that the keyword expansion engine 30 may also be configured as an independent module externally linked to the sever 12. The keyword expansion engine 30 may be configured to automatically populate the keyword database 16 with keywords as the plurality of keywords is generated. Alternatively, the keyword expansion engine 30 may be configured to populate the keyword database 16 upon completely generating the plurality of keywords.

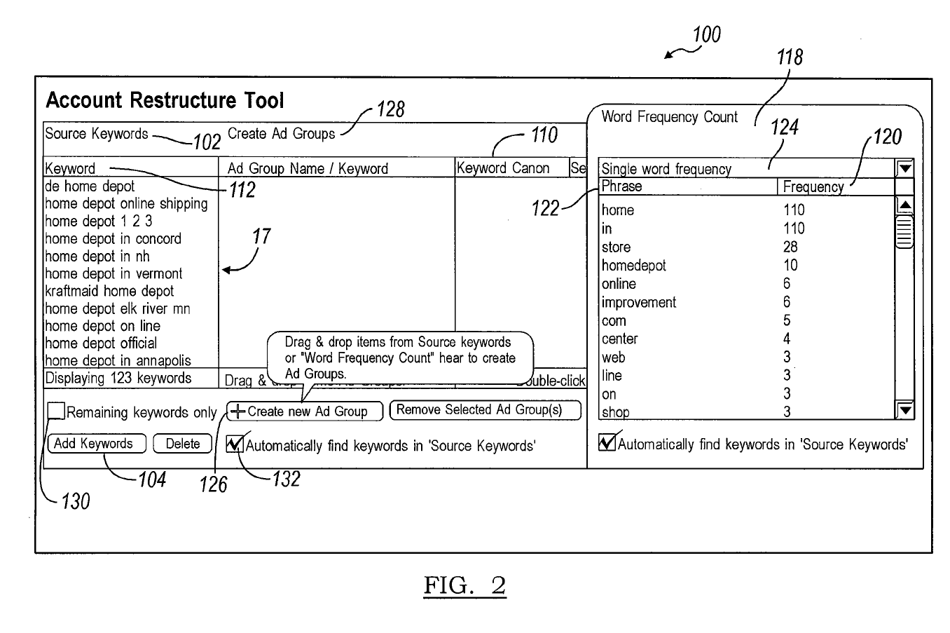

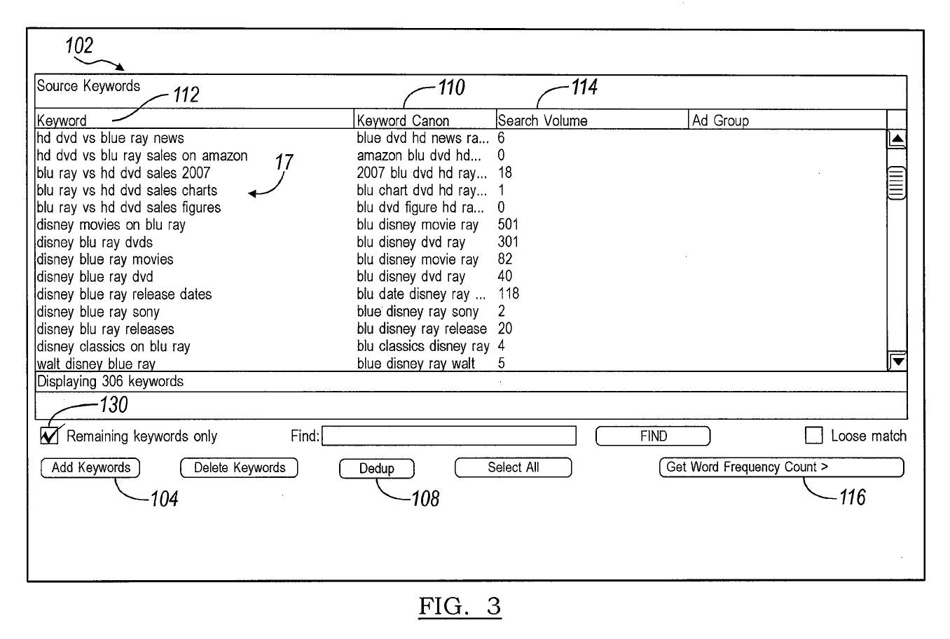

Referring now to FIGS. 2-4, a graphical user interface 100 for creating a plurality of ad groups 27 using the system 10 described herein is shown. As best illustrated in FIG. 3, the interface 100 includes a field labeled as “Source Keywords” 102 for receiving and storing a list 17 of keywords 21. As used herein, a “list of keywords” may include any number of keywords, including zero. The “Source Keywords” field 102 is a graphical depiction of the contents stored in the keyword database 16. A user begins the ad grouping process by inserting a list 17 of keywords 21 into the keyword database 16. For instance, the user may click on an “Open” tab (not shown) to retrieve a saved file containing a list 17 of keywords 21.

Alternatively, a user may insert one or more keywords into the Source Keywords field 102 to create a list 17 of keywords 21. A user may insert keywords into the Source Keywords field 102 according to any number of methods. For instance, the user may simply drag one or more keywords from a separate document and drop them into the Source Keywords field 102. Similarly, the user may cut or copy one or more keywords from a separate application and paste them into the Source Keywords field 102. Alternatively, the user may click on the “Add Keywords” tab 104 and manually input one or more keywords.

If the user desires additional keywords, the user may utilize the keyword expansion engine 30 (from FIG. 1) to generate a plurality of keywords. For instance, the user may select one or more keywords from the list 17 of keywords 21 displayed in the Source Keywords field 102 and input the keyword into the keyword expansion engine 30 so that the keyword expansion engine 30 may generate a plurality of related keywords. Similarly, the user may provide the keyword expansion engine 30 with one or more keywords related to the list 17 of keywords 21 displayed in the Source Keywords field 102. In the event that the user does not have a previously established list 17 of keywords 21, the user may similarly utilize the keyword expansion engine 30 to generate a new list 17 of keywords 21. For example, the user may enter one or more keywords into the keyword expansion engine relating to a theme or ad campaign(s) of interest to the user.

Alternatively, if the user wishes to reduce the number of keywords displayed in the Source Keywords field 102, the user may select (e.g., highlight) one or more keywords from the list 17 of keywords 21 in the Source Keywords field 102 and click the “Delete Keywords” tab 106 to delete the selected keyword(s). In addition, the user may click on the “Dedup” control 108 depicted in FIG. 1 to narrow the list 17 of keywords 21 according to predetermined canonicals associated with each keyword. The functionality of the Dedup control 108 is governed by the canonicalization engine 24 discussed above.

As illustrated in the drawings, the Source Keywords field 102 includes a “Keyword Canon” column 110 indicating a common keyword associated with each keyword displayed in the “Keyword” column 112. By way of example, the keyword canon “blu disney dvd ray” in FIG. 3 encompasses a plurality of keywords such as the keyword “disney blu ray dvds.” Thus, if the user clicks on the Dedup control 108, the keyword “disney blu ray dvds” and any other keywords similarly encompassed by the keyword canon “blu disney dvd ray” would be eliminated from the list 17 of keywords 21 displayed in the Source Keywords field 102, whereas the keyword “blu disney dvd ray” would remain. According to another example, if the Source Keywords field 102 contains a list 17 of keywords 21 consisting of “car,” “cars,” “my car,” and “my cars,” the canonicalization engine 24 may be operable to reduce the foregoing list 17 of keywords 21 to “car” in response to a user clicking on the Dedup 108 control. Thus, “car” would be the only keyword displayed to the user in the Source Keywords field 102.

Once the Source Keywords field 102 has been populated with a list 17 of keywords 21, the user may then categorize the list 17 of keywords 21. For instance, the user may initially categorize the list 17 of keywords 21 according to search volume. As illustrated in FIG. 3, the Source Keywords field 102 includes a “Search Volume” column 114. The Search Volume column 114 graphically lists the total volume of search requests logged by the search logs 20 for each keyword in the list 17 of keywords 21. Thus, the Search Volume column 114 may list the total number of search requests conducted over a network for each keyword in the Keyword column 112. For instance, the numeral “6” in the Search Volume column 114 in FIG. 3 indicates that six search requests for the keyword “hd dvd vs blue ray news” were conducted by users during the last day, week, month, etc.

If the user clicks on the Search Volume cell 114, the categorization engine 22 will categorize the list 17 of keywords 21 in the Keyword column 112 according to their corresponding search volume. Thus, the keywords in the Keyword column 112 may be subsequently categorized in ascending order such that the top-ranked keyword displayed to the user has the highest search volume and the lowest-ranked keyword has the lowest search volume. Alternatively, the user may click on the Search Volume cell 114 so that the keywords in the Keyword column 112 are displayed to the user in reverse order. Based on the total number of search requests conducted for a given keyword, the user may decide to add or delete one or more keywords from the Source Keywords field 102. For instance, if the Search Volume column 114 indicates a relatively high search volume for a given keyword, the user may wish to add similar keywords (e.g., by way of the keyword expansion engine 30). On the other hand, if the Search Volume column 114 indicates a relatively low search volume for a given keyword, the user may choose to delete this keyword as being unimportant.

In addition, the user may click on the “Get Word Frequency Count” control 116 depicted in FIG. 3 to categorize the list 17 of keywords 21 according to frequency of occurrence. The functionality of the “Get Word Frequency Count” tab 116 is governed by the word frequency engine 18 discussed above. Upon clicking on the “Get Word Frequency Count” control 116, a “Word Frequency Count” window 118 will be displayed to the user. By default, the word frequency engine 18 may initially calculate the frequency of occurrence associated with each keyword in list 17 of keywords 21 displayed in the “Source Keywords” field 102 according to a single word frequency. In FIG. 2, for example, it can be seen that the word frequency engine 18 has calculated that the keywords “home” and “depot” each occur in the Keyword column 112 one hundred and ten times.

Once the word frequency engine 18 has calculated the frequency of occurrence associated with each keyword, the categorization engine 22 subsequently categorizes the list 17 of keywords 21 accordingly. For instance, the categorization engine 22 may categorize the list 17 of keywords 21 in descending order, such that the top-ranked keyword displayed to the user has the highest frequency of occurrence and the lowest-ranked keyword has the lowest frequency of occurrence. Alternatively, the user may click on the “Frequency” tab 120 so that the keywords in the “Phrase” field 122 are displayed to the user in reverse order.

As previously mentioned, the word frequency engine 18 is operable to calculate the frequency of occurrence associated with each keyword in the list 17 of keywords 21 according to any word size. Upon clicking on the “Single Word Frequency” tab 124, a drop down menu (not shown) displays a list of word frequency sizes (e.g., “Two Word Frequency,” “Three Word Frequency,” etc.) that the user may select. It should be understood that the word frequency sizes displayed to the user may consist of any suitable range (e.g., “Two Word Frequency” to “One-Hundred Word Frequency”). Should the user select “Three Word Frequency,” the word frequency engine 18 will calculate the frequency of occurrence corresponding to keywords comprised of least three words. In the list 17 of keywords 21 under the Keyword column 112 in FIG. 2, for example, the word frequency engine 18 will calculate how many times keywords such as “home depot in” occur among the list 17 of keywords 21.

The user may begin grouping keywords into a plurality of ad groups 27 according to the frequency of occurrence corresponding to each keyword in the list 17 of keywords 21. As the banner corresponding to the “Create New Ad Group” tab 126 in FIG. 2 indicates, the user may create an ad group by dragging one or more keywords from the Source Keywords field 102 or the Word Frequency Count field 118 and dropping the selected keywords into the “Create Ad Groups” field 128 (the Create Ad Groups field 128 graphically depicts the contents of the ad group database 28). Alternatively, if the user clicks on the “Create New Ad Group” tab 126, a window (now shown) will subsequently be displayed for allowing the user to manually create a new ad group.

In the event that a user manually creates an group (i.e., as opposed to dragging and dropping keywords into the Create Ad Groups field 128), the user may check the “Automatically find keywords in ‘Source Keywords’” box 130 so that all keywords in the Source Keyword field 102 corresponding to that given ad group are highlighted. Thus, the user may subsequently select one or more of the highlighted keywords to drag and drop into the newly created ad group. Alternatively, the keyword allocation module 26 may be configured to automatically group all corresponding keywords in the Source Keyword field 102 in the newly created ad group. For instance, as an ad group is created, keywords corresponding to that given ad group are preferably automatically eliminated from the Source Keywords field 102 and/or the Word Frequency Count 118 field so that only ungrouped keywords are displayed to the user. Alternatively, the Source Keywords field 102 and/or the Word Frequency Count 118 field may include a “Remaining keywords only” box 130 for a user to check so that only ungrouped keywords are displayed.

A user may also group keywords into a plurality of ad groups 27 according to a predetermined ad grouping list 31. More particularly, the user may specify that certain keywords must be grouped into a predetermined ad group. By way of example, if a user wants to group each keyword in the Keyword column 112 in FIG. 1 having the keyword “home depot” into a specific ad group, the user can click on the Create New Ad Group tab 126 and manually create an ad group titled “home depot.” The user may then check the “Automatically find keywords in ‘Source Keywords’” box 132 to highlight all keywords in the Keyword column 112 having the keyword “home depot,” and subsequently group the highlighted keywords into the “home depot” ad group.

According to an alternative embodiment, keywords may be grouped into ad groups based on a predetermined ad grouping list 31 by way of a more automated process. For instance, a user may insert or upload a predetermined ad grouping list 31 into the Source Keywords field 102 and subsequently drag and drop that list into the Create Ad Groups field 128. Similarly, the user may simply select (e.g., cut, copy, drag, etc.) a predetermined ad grouping list 31 from an external document and drop or paste the list directly into the “Create Ad Groups” field 128. Either way, the keyword allocation module 26 is configured to automatically group each keyword in the Source Keyword field 102 corresponding to a keyword in the predetermined ad grouping list 31 into the specified ad group. Thus, if a user inserts a predetermined ad grouping list 31 including the keyword “disney” into the Create Ad Groups field 128, the ad allocation module 26 will automatically group each keyword in list 17 of keywords 21 displayed in the Keyword column 112 depicted in FIG. 3 including the keyword “disney” into a “disney” ad group.

The keyword allocation module 26 may further be configured to automatically group any ungrouped keywords. Thus, if any keywords are remaining in the Source Keywords field 102 after the keyword allocation module 26 has grouped keywords according to a predetermined ad grouping list 31, the keyword allocation module 26 may be configured to group the remaining keywords according to a predetermined ad grouping strategy. For instance, using various algorithms known to those of ordinary skill in the art, the keyword allocation module 26 may be trained to group keywords according to their corresponding frequency of occurrence. To illustrate, the keyword allocation module 26 may begin creating ad groups using the largest sized keywords (i.e., phrases consisting of the most keywords) having a frequency of occurrence falling within a predetermined range. Thus, if the largest phrase in a list 17 of keywords 21 consists of five keywords, the categorization engine 22 would categorize the remaining keywords according to a “Five Word Frequency,” and the keyword allocation module 26 would group these keywords accordingly. This process would be repeated according to a “Four Word Frequency,” “Three Word Frequency,” and so on. Similarly, the keyword allocation module 26 may be configured to only create ad groups using keywords having search volumes exceeding a predetermined threshold.

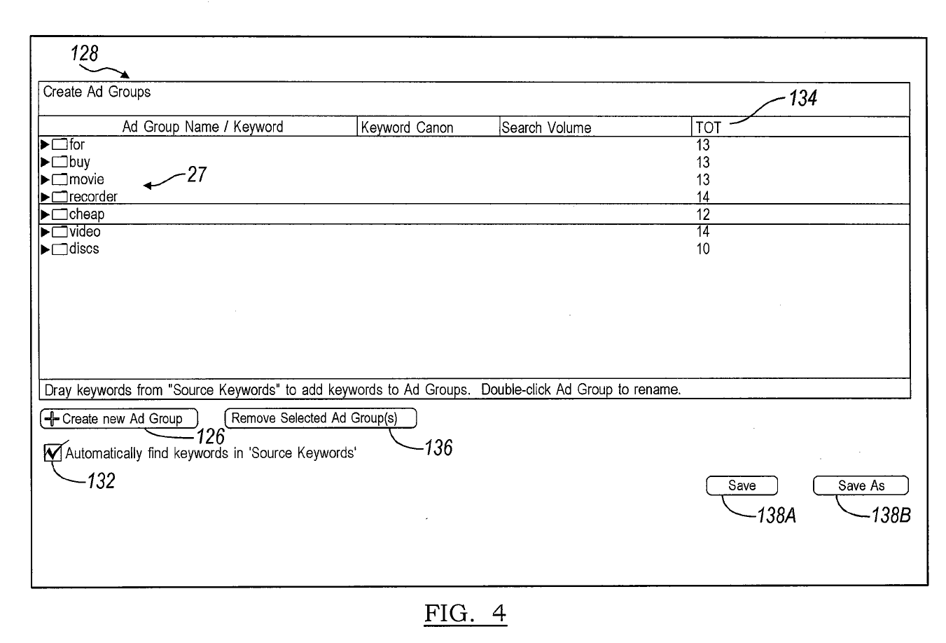

FIG. 4 illustrates the Create Ad Groups window 128 with a set of sample ad groups 27 in their collapsed form. To expand and view the contents of a. given ad group, a user may simply click on the ad group. By way of example, the ad group “for” includes thirteen keywords (as indicated in the “Total” column 134) having the keyword word “for.” To view these thirteen keywords, the user may simply click the “for” folder. Moreover, an ad group may be deleted simply by selecting (e.g., highlighting) the given ad group and clicking on the “Remove Selected Ad Group(s)” tab 136. Furthermore, any ungrouped keywords may be grouped into a default ad group which may be labeled as “Miscellaneous.” Upon completing the ad grouping process, the user may click on the “Save” 138A or “Save As” tab 138B to save the file into an uploadable format. The saved file may then be automatically or selectively exported to any compatible application or program known in the art, such as, but not limited to, a spreadsheet application.

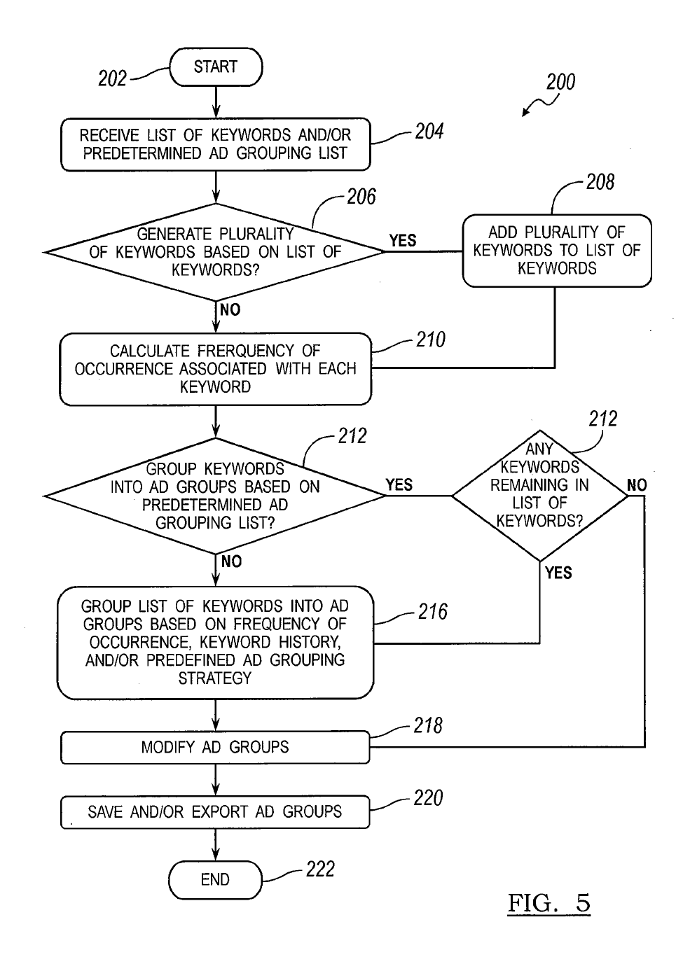

Referring now FIG. 5, a method 200 for automatically grouping a list 17 of keywords 21 into a plurality of ad groups 27 starts in step 202. In step 204, the list 17 of keywords 21 to be grouped into ad groups is received. Additionally, a predetermined ad grouping list 31 may be received at any time during the ad grouping process. The list 17 of keywords 21 and/or predetermined ad grouping list 31 may be stored in the keyword database 16 discussed above. In step 206, a user has the option of generating a plurality of keywords, which may be done by way of the keyword expansion engine 30 discussed above. If the user so elects, a plurality of related keywords is generated based on one or more terms provided by the user, wherein the plurality of related keywords is added to the list 17 of keywords 21 in step 208. If the user declines to have a plurality of keywords generated, a frequency of occurrence associated with each keyword in the list 17 of keywords 21 is calculated in step 210. The frequency of occurrence may be calculated by way of the word frequency engine 18 discussed above. If a predetermined ad grouping list 31 was received in step 204, the list 17 of keywords 21 are grouped into ad groups based on the predetermined ad grouping list 31 in step 212. In step 214, the method determines whether any keywords in the list 17 of keywords 21 remain ungrouped after keywords have been grouped into ad groups based on the predetermined ad grouping list 31. If so, the method proceeds to step 216. Alternatively, if all keywords have been grouped in step 212, the method proceeds to step 118.

If a predetermined ad grouping list 31 was not received in step 204, the method proceeds to step 216. In step 216, the list 17 of keywords 21 are grouped into a plurality of ad groups 27 based on their corresponding frequencies of occurrence, search volumes, and/or a predetermined ad grouping strategy. In step 218, one or more ad groups may be modified by a user prior to finalizing the ad grouping process. In step 220, the plurality of ad groups 27 are saved and may be exported to a spreadsheet application such as a bulk sheet. The method ends at step 222.

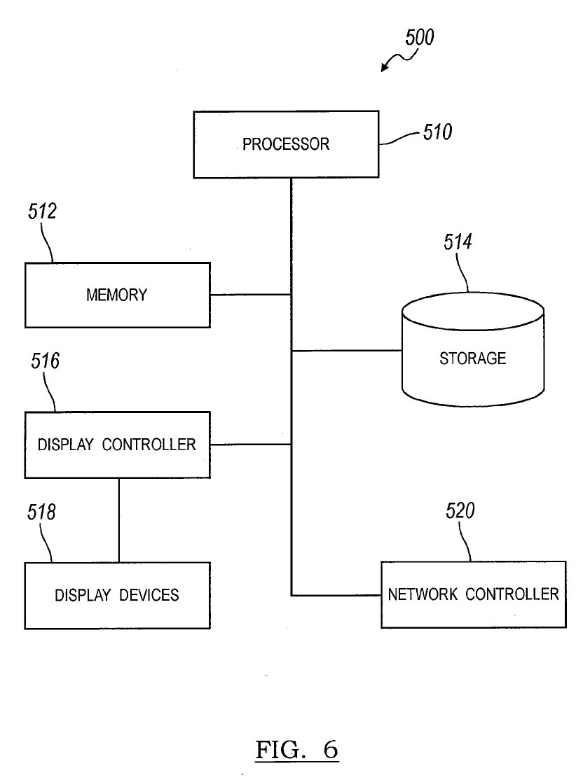

Any of the modules, servers, or engines described may be implemented in one or more computer systems. One exemplary system is provided in FIG. 6. The computer system 500 includes a processor 510 for executing instructions such as those described in the methods discussed above. The instructions may be stored in a computer readable medium such as memory 512 or storage devices 514, for example a disk drive, CD, or DVD. The computer may include a display controller 516 responsive to instructions to generate a textual or graphical display on a display device 518, for example a computer monitor. In addition, the processor 510 may communicate with a network controller 520 to communicate data or instructions to other systems, for example other general computer systems. The network controller 520 may communicate over Ethernet or other known protocols to distribute processing or provide remote access to information over a variety of network topologies, including local area networks, wide area networks, the Internet, or other commonly used network topologies.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this application. This description is not intended to limit the scope or application of this application in that the system 10 is susceptible to modification, variation and change, without departing from spirit of this application, as defined in the following claims.

I claim:

1. A system for automatically grouping keywords into ad groups, comprising:
a keyword database for receiving a list of keywords;
a word frequency engine for calculating a frequency of occurrence associated with each keyword in the list of keywords;
a categorization engine for categorizing each keyword in the list of keywords according to the frequency of occurrence; and
a keyword allocation module for allocating the list of keywords into a plurality of ad groups based on the frequency of occurrence, each ad group including a set of keywords selected from the list of keywords, the keyword allocation module storing the plurality of ad groups in an ad group database.

2. The system of claim 1, wherein the frequency of occurrence is based on a frequency that each keyword occurs in the list of keywords.

3. The system of claim 2, wherein the keyword database is configured to receive a predetermined ad grouping list, and
wherein the keyword allocation module allocates each keyword in the list of keywords into a plurality of ad groups based on at least one of the predetermined ad grouping list and the frequency of occurrence.

4. The system of claim 3, further comprising a keyword expansion engine in communication with the keyword database, the keyword expansion engine being operable to receive at least one keyword, the at least one keyword received being one of a keyword related to an ad campaign associated with the list of keywords or at least one keyword selected from the list of keywords,
wherein the keyword expansion engine is configured to generate a plurality of keywords based on the at least one keyword received, wherein the plurality of keywords are automatically added to the list of keywords.

5. The system of claim 4, further comprising a graphical user interface for enabling a user to add one or more keywords to the list of keywords in the keyword database, the graphical user interface further enabling the user to delete one or more keywords from the list of keywords in the keyword database.

6. The system of claim 4, further comprising a canonicalization engine for narrowing the list of keywords according to a predetermined canonicalization criterion.

7. The system of claim 4, further comprising at least one search log in communication with the keyword database, the at least one search log being communicatively linked to at least one search engine via a network,
wherein the at least one search log is configured to determine a historical search volume associated with each keyword,
wherein the historical search volume associated with each keyword is based on a total volume of searches conducted by users via the network during a predetermined period of time.

8. The system of claim 7, wherein the keyword allocation module allocates each keyword in the list of keywords into a plurality of ad groups based on at least one factor selected from a group consisting of: a predefined ad grouping strategy, the historical search volume associated with each keyword, the predetermined ad grouping list, and the frequency of occurrence.

9. The system of claim 7, further comprising a graphical user interface for enabling a user to reallocate one or more keywords among the plurality of ad groups according to a desired preference.

10. A method of automatically grouping keywords into ad groups, the method comprising:
receiving a list of keywords;
storing the list of keywords into a keyword database;
determining a frequency of occurrence associated with each keyword in the plurality of keywords;
categorizing each keyword in the plurality of keywords according to the frequency of occurrence;
grouping the list of keywords into a plurality of ad groups based on the frequency of occurrence, each ad group including a set of keywords selected from the list of keywords; and
storing the plurality of ad groups into an ad group database.

11. The method of claim 10, wherein the frequency of occurrence is based on a frequency that each keyword occurs in the list of keywords.

12. The method of claim 11, further comprising receiving a predetermined ad grouping list, wherein grouping each keyword in the list of keywords into the plurality of ad groups is based on at least one of the predetermined ad grouping list and the frequency of occurrence.

13. The method of claim 12, further comprising:
generating a plurality of keywords based on at least one keyword, the at least one keyword being one of a keyword related to an ad campaign associated with the list of keywords or at least one keyword selected from the list of keywords; and
automatically adding the plurality of keywords to the list of keywords.

14. The method of claim 13, further comprising:
enabling a user to add one or more keywords to the list of keywords; and
enabling a user to delete one or more keywords from the list of keywords.

15. The method of claim 13, further comprising narrowing the list of keywords according to a predetermined canonicalization criterion.

16. The method of claim 13, wherein grouping each keyword in the list of keywords into a plurality of ad groups is based on at least one factor selected from a group consisting of: a historical search volume associated with each keyword, a predefined ad grouping strategy, the predetermined ad grouping list, and the frequency of occurrence.

17. The method of claim 16, wherein the historical search volume associated with each keyword is based on a total volume of searches conducted by users via a network during a predetermined period of time.

18. The method of claim 16, further comprising enabling a user to modify the plurality of ad groups according to a desired preference.

19. The method of claim 18, wherein enabling the user to modify the plurality of ad groups comprises any one of the following: reallocating one or more keywords among the plurality of ad groups, regrouping one or more keywords in an ad group into a new ad group, adding one or more keywords to an ad group selected from the plurality of ad groups, or deleting one or more keywords from an ad group selected from the plurality of ad groups.

20. The method of claim 16, further comprising saving the plurality of ad groups as an uploadable file.

21. In a computer readable storage medium having stored therein instructions executable by a programmed processor for automatically grouping keywords into ad groups, the storage medium comprising instructions for:
receiving a list of keywords;
storing the list of keywords in a keyword database;
determining a frequency of occurrence associated with each keyword in the plurality of keywords;
categorizing each keyword in the plurality of keywords according to the frequency of occurrence; and
grouping the list of keywords into a plurality of ad groups based on the frequency of occurrence, each ad group including a set of keywords selected from the list of keywords; and
storing the plurality of ad groups into an ad group database.

22. The computer readable storage medium of claim 21, wherein the frequency of occurrence is based on a frequency that each keyword occurs in the list of keywords.

23. The computer readable storage medium of claim 22, further comprising receiving a predetermined ad grouping list, wherein grouping each keyword in the list of keywords into the plurality of ad groups is based on at least one of the predetermined ad grouping list and the frequency of occurrence.

24. The computer readable storage medium of claim 23, further comprising:
generating a plurality of keywords based on at least one keyword, the at least one keyword being one of a keyword related to an ad campaign associated with the list of keywords or at least one keyword selected from the list of keywords; and
automatically adding the plurality of keywords to the list of keywords.

25. The computer readable storage medium of claim 24, further comprising:
enabling a user to add one or more keywords to the list of keywords; and
enabling a user to delete one or more keywords from the list of keywords.

26. The computer readable storage medium of claim 24, further comprising narrowing the list of keywords according to a predetermined canonicalization criterion.

27. The computer readable storage medium of claim 24, wherein grouping each keyword in the list of keywords into a plurality of ad groups is based on at least one factor selected from a group consisting of: a historical search volume associated with each keyword, a predefined ad grouping strategy, the predetermined ad grouping list, and the frequency of occurrence.

28. The computer readable storage medium of claim 26, wherein the historical search volume associated with each keyword is based on a total volume of searches conducted by users via a network during a predetermined period of time.

29. The computer readable storage medium of claim 27, further comprising enabling a user to modify the plurality of ad groups according to a desired preference.

30. The computer readable storage medium of claim 29, wherein enabling the user to modify the plurality of ad groups comprises any one of the following: reallocating one or more keywords among the plurality of ad groups, regrouping one or more keywords in an ad group into a new ad group, adding one or more keywords to an ad group selected from the plurality of ad groups, or deleting one or more keywords from an ad group selected from the plurality of ad groups.
